(19) United States
(12) Patent Application Publication
(10) Pub. No.: US 2026/0227311 A1
(43) Pub. Date: Aug. 6, 2026

(54) CONTROL VARIABLE ADJUSTMENT FOR FLOW CYTOMETRY WAVEFORM ACQUISTION

(71) Applicant: Beckman Coulter, Inc., Brea, CA (US)

(72) Inventors: Robert J. ZIGON, Carmel, IN (US); Larry MYERS, Greenfield, IN (US)

(73) Assignee: Beckman Coulter, Inc., Brea, CA (US)

(21) Appl. No.: 19/150,848

(22) PCT Filed: Jan. 22, 2024
(86) PCT No.: PCT/US24/12414

§ 371 Date: Jul. 24, 2025

Related U.S. Application Data
(60) Provisional application No. 63/481,293, filed on Jan. 24, 2023.

(51) Int. Cl. G01N 15/14; G01N 15/1429

(52) U.S. Cl. CPC G01N 15/1425; G01N 15/1429

(57) ABSTRACT

A flow cytometer adjusts one or more control variables of a light source, a fluidic system, and an optical system based on a first set of values. The flow cytometer acquires a sequence of waveform data from particles streaming through a light beam in an interrogation zone under the first set of values for the one or more control variables. The flow cytometer adjusts the one or more control variables at predetermined intervals to acquire additional sequences of the waveform data using different sets of values for the one or more control variables.

This application is being filed on Jan. 22, 2024, as a PCT International application and claims the benefit of and priority to U.S. Provisional Patent Application No. 63/481,293 filed on Jan. 24, 2023, the disclosure of which is hereby incorporated by reference in its entirety.

### BACKGROUND

Flow cytometry is a technique for detecting and analyzing chemical and physical characteristics of cells or particles in a fluid sample. For example, a flow cytometer may be used to assess cells from blood, bone marrow, tumors, or other body fluids. Typically, the sample is passed through a fluid nozzle which aligns particles in a single file line within a sheath fluid. A laser beam illuminates the particles as they pass through in single file to generate radiated light including forward scattered light, side scattered light, and fluorescent light. The radiated light can then be detected and analyzed to determine one or more characteristics of the particles.

### SUMMARY

In general terms, the present disclosure relates to analyzing particles using flow cytometry. In one possible configuration, one or more control variables are automatically adjusted to have different values for acquiring sequences of waveform data. Various aspects are described in this disclosure, which include, but are not limited to, the following aspects.

One aspect relates to a flow cytometer for analyzing particles, the flow cytometer comprising: a light source generating a light beam toward an interrogation zone; a fluidic system streaming the particles through the light beam in the interrogation zone; an optical system including detectors for detecting radiated light from the particles streaming through the light beam in the interrogation zone; and a processing circuitry having non-transitory computer readable storage media storing instructions which, when executed by the processing circuity, cause the processing circuitry to: adjust one or more control variables of the light source, the fluidic system, and the optical system based on a first set of values; acquire a sequence of waveform data from the particles streaming through the light beam in the interrogation zone under the first set of values for the one or more control variables; and adjust the one or more control variables at predetermined intervals to acquire additional sequences of the waveform data using different sets of values for the one or more control variables.

Another aspect relates to a method of analyzing particles flowing through an interrogation zone of a flow cytometer, the method comprising: adjusting one or more control variables based on a first set of values, the one or more control variables being used to control operation of at least one of: a light source generating a light beam toward the interrogation zone; a fluidic system causing a flow of the particles through the light beam in the interrogation zone; and an optical system for detecting one or more characteristics of the particles flowing through the light beam in the interrogation zone; acquiring a sequence of waveform data from the particles flowing through the light beam in the interrogation zone under the first set of values for the one or more control variables; and adjusting the one or more control variables at predetermined intervals to acquire additional sequences of the waveform data using different sets of values for the one or more control variables.

Another aspect relates to a non-transitory computer readable medium comprising program instructions, which when executed by a processor, cause the processor to: adjust one or more control variables based on a first set of values, the one or more control variables being used to control operation of at least one of: a light source generating a light beam toward an interrogation zone; a fluidic system causing a flow of particles through the light beam in the interrogation zone; and an optical system for detecting one or more characteristics of the particles flowing through the light beam in the interrogation zone; acquire a sequence of waveform data from the particles flowing through the light beam in the interrogation zone under the first set of values for the one or more control variables; and adjust the one or more control variables at predetermined intervals to acquire additional sequences of the waveform data using different sets of values for the one or more control variables.

A variety of additional aspects will be set forth in the description that follows. The aspects can relate to individual features and to combination of features. It is to be understood that both the foregoing general description and the following detailed description are exemplary and explanatory only and are not restrictive of the broad inventive concepts upon which the embodiments disclosed herein are based.

### BRIEF DESCRIPTION OF THE DRAWINGS

The following drawing figures, which form a part of this application, are illustrative of the described technology and are not meant to limit the scope of the disclosure in any manner.

FIG. 1 schematically illustrates an example of a flow cytometer system.

FIG. 2A shows an example of a particle entering an interrogation zone of the flow cytometer in the system of FIG. 1.

FIG. 2B shows an example of the particle passing through a central area of the interrogation zone of FIG. 2A.

FIG. 2C shows an example of the particle exiting the interrogation zone of FIG. 2A.

FIG. 3 schematically illustrates an example of a waveform analysis device of the flow cytometer system of FIG. 1.

FIG. 4 schematically illustrates an example of a method of performing a flow cytometry experiment by the flow cytometer system of FIG. 1.

FIG. 5 graphically illustrates an example of waveform data that can be generated after completion of the method of FIG. 4.

FIG. 6 illustrates an example of a graphical user interface that can be generated by a waveform analysis device using the waveform data of FIG. 5.

FIG. 7 illustrates an example of a graphical user interface that can be generated by a waveform acquisition device of the flow cytometer system of FIG. 1.

FIG. 8 illustrates an example of a graphical user interface generated by the waveform acquisition device following a selection of an icon on the graphical user interface of FIG. 7.

FIG. 9 illustrates an exemplary architecture of a computing device that can be used to implement aspects of the present disclosure.

### DETAILED DESCRIPTION

Various embodiments will be described in detail with reference to the drawings, where like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims.

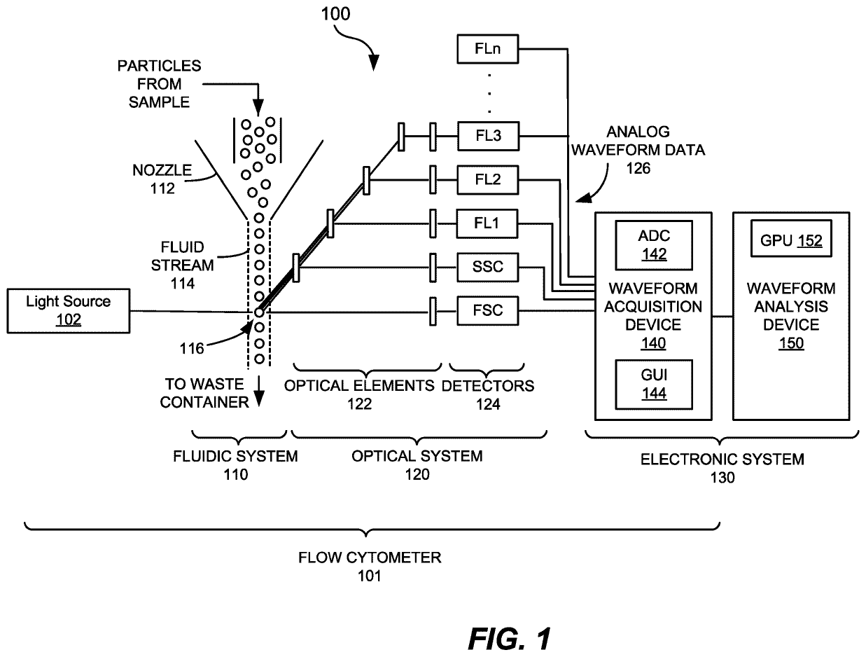

FIG. 1 schematically illustrates an example of a flow cytometer system 100. In some instances, the flow cytometer system 100 can include aspects and features described in U.S. Provisional Patent Application No. 63/410,984, entitled Flow Cytometry Waveform Processing, filed Sep. 28, 2022, U.S. Provisional Patent Application No. 63/481,289, entitled Threshold Logic for Flow Cytometry Waveform Analysis, filed Jan. 24, 2023, and U.S. Provisional Patent Application No. 63/481,298, entitled Doublet Analysis in Flow Cytometry, filed Jan. 24, 2023, which are herein incorporated by reference in their entireties.

In general, flow cytometry is a technique for measuring and analyzing properties of particles or cells when flowing in a fluid stream. Data from millions of particles or cells can be collected by the flow cytometer system 100 in a matter of minutes and displayed in a variety of formats. Illustrative example applications of flow cytometry include phenotyping to identify and count specific cell types within a population, analyzing DNA or RNA content within cells, determining presence of antigens on a surface or within cells, and assessing cell health status.

As shown in the illustrative example of FIG. 1, the flow cytometer system 100 generally includes three main component subsystems: a fluidic system 110, an optical system 120, and an electronic system 130. The fluidic system 110 includes a nozzle 112 which receives a sample containing particles or cells suspended in a fluid. The nozzle 112 creates a fluid stream 114 of the particles or cells arranged in a single file line. Each particle or cell passes through one or more light beams produced by a light source 102. The point at which a particle or cell intersects with the one or more light beams of the light source 102 is known as an interrogation zone 116. In some examples, the light source 102 includes one or more lasers.

The optical system 120 includes the light source 102, optical elements 122, and detectors 124. At the interrogation zone 116, light from the light source 102 hits a particle or cell in the fluid stream 114 and scatters. The optical elements 122 direct the scattered light toward the detectors 124. The detectors 124 can include a forward scatter (FSC) detector to measure scatter in the path of the light source 102, a side scatter (SSC) detector to measure scatter at a ninety-degree angle relative to the light source 102, and one or more fluorescence detectors (FL1, FL2, FL3 . . . FLn) to measure the emitted fluorescence intensity at different wavelengths of light.

Generally, FSC intensity is proportional to the size or diameter of a particle due to light diffraction around the particle. FSC may therefore be used for the discrimination of particles by size. SSC, on the other hand, is produced from light refracted or reflected by internal structures of the particle and may therefore provide information about the internal complexity or granularity of the particle. By adding fluorescent labelling to a sample, different fluorescent signals/channels (e.g., green, orange, and red) can be analyzed for functional characteristics of a cell. For example, since T-cells present CD3 binding sites, a sample containing T-cells may be “stained” with anti-CD3 antibodies conjugated with a fluorescent molecule. As these cells pass through the interrogation zone 116, the light from the source light excites the fluorescent tag, or fluorochrome, to emit photons at a wavelength detectable by a fluorescence detector. The detectors 124 may therefore simultaneously measure several parameters and enable categorization of particles by their function based on detected wavelengths of light.

The electronic system 130 includes a waveform acquisition device 140 and a waveform analysis device 150. The waveform acquisition device 140 is communicatively coupled with the detectors 124 to receive analog waveform data 126 generated by the detectors 124. The waveform acquisition device 140 includes an analog-to-digital converter (ADC) 142 configured to digitize the analog waveform data 126. The waveform acquisition device 140 can also include a graphical user interface (GUI) 144 for receiving user inputs. The user inputs received via the GUI 144 can be used to control one or more control variables of the fluidic system 110 and optical system 120 for analyzing the particles in the fluid stream 114.

The waveform analysis device 150 is configured to receive the digital waveform data and display it for a user of the flow cytometer system 100. In some embodiments, the waveform analysis device 150 comprises a computing device communicatively coupled with a flow cytometer 101, such as over a network. The flow cytometer 101 may include the fluidic system 110, optical system 120, and waveform acquisition device 140. In other embodiments, the waveform analysis device 150 is integrated with the flow cytometer 101.

Current flow cytometers use a field-programmable gate array (FPGA) in the waveform acquisition device to obtain information about individual particles passing through the light beam. The waveform acquisition device uses a single threshold value to determine when the output of the detectors begins conversion from analog to digital. Only a single threshold value can be used for a single run of a sample through current flow cytometers. The threshold value is a constant value and may be referred to as a voltage threshold value. As such, if or when a detector outputs a voltage value that crosses the threshold, digitization begins, and the digital value is sent to the FPGA. As waveform data is digitized, the FPGA computes the height, width, and area of each pulse. Besides these parameters, other data relating to the waveform, including data not exceeding the voltage threshold value, is not captured, stored, or otherwise available for analysis by current flow cytometers. Also, if a user wishes to adjust the threshold value, the experiment must be re-run with the new threshold value, incurring costs in resources and time.

To address the above issues, the flow cytometer system 100 is improved with a graphics processing unit (GPU) 152. In the example illustrated in FIG. 1, the GPU 152 is shown included as a component of the waveform analysis device 150. The GPU 152 processes a continuous digital stream generated by the waveform acquisition device 140. The digital stream is continuous in that the waveform acquisition device 140 does not threshold the waveform data produced by the detectors 124. In contrast to current flow cytometry techniques, during an experiment, the waveform acquisition device 140 continuously digitizes the analog waveform data 126 at a high rate (e.g., 1 GHz) without thresholding. In some instances, the GPU 152 enables removal of the FPGA from the waveform acquisition device 140.

The waveform analysis device 150 receives a digitized version of the waveform data with increased data points, and the waveform data for an experiment is displayed and available in its entirety for processing by the GPU 152. In addition to having the capability of processing a large stream or file of waveform data, the GPU 152 enables thresholding of the waveform at the post-processing step as opposed to the waveform acquisition step. This in turn provides several technical benefits including the ability to dynamically adjust thresholds and update graphical plots in real-time without re-running an experiment. The GPU 152 may also measure and extract relevant information present in the waveform data beyond the three parameters of height, width, and area. Further details of these advantages are discussed below.

The flow cytometer system 100 includes elements which are shown and described for purposes of discussion, and it will be appreciated that numerous variations in components and functions are possible. For example, the optical elements 122 may include a series of filters, dichroic mirrors, and/or beam splitters to select different wavelengths of light and provide a wavelength to the appropriate detector. The detectors 124 may comprise photomultiplier tubes (PMTs) or avalanche photodiodes (APDs) or single photon counting devices.

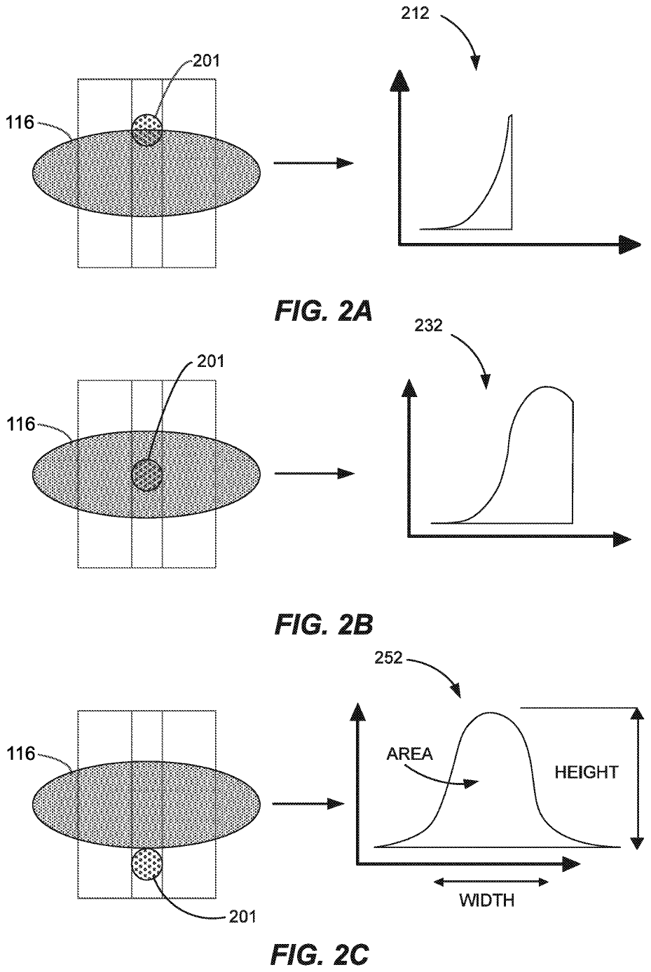

FIGS. 2A-2C illustrate examples of waveform data generated by a particle 201 as it passes through the interrogation zone 116. As the particle 201 passes through the interrogation zone 116, a pulse is detected by one or more of the detectors 124.

FIG. 2A shows an example of the particle 201 entering the interrogation zone 116. As the particle 201 starts to intersect with the interrogation zone 116, the particle 201 begins to generate scattered light and fluorescence signals. The detector 124 produces a current or voltage that is proportional to the scattered light and fluorescence signals. The output of the detector 124 begins to rise as shown in plot 212 due to current flowing in the detector 124.

FIG. 2B shows an example of the particle 201 passing through a central area of the interrogation zone 116. As the particle 201 continues to move through the interrogation zone 116, the particle 201 becomes fully illuminated. Since photon density is highest in the central portion of the interrogation zone 116, a maximum amount of optical signal is produced in this example. As shown in plot 232, the current or voltage of the detector 124 peaks when the particle 201 passes through the central area of the interrogation zone 116.

FIG. 2C shows an example of the particle 201 exiting the interrogation zone 116. As the particle 201 exits the interrogation zone 116, the current or voltage output of the detector 124 returns to the baseline. The generation of the pulse shown in plot 252 is called an event.

The height of the plot 252 represents the maximum current/voltage output by the detector 124 which can be proportional to the signal intensity and size of the particle, the width of the plot 252 represents the time it took for the particle to pass through the interrogation zone 116, and the area under the plot 252 can represents the signal intensity and size of the particle. Accordingly, the height, width, and area of the plot 252 can be used to characterize the particle.

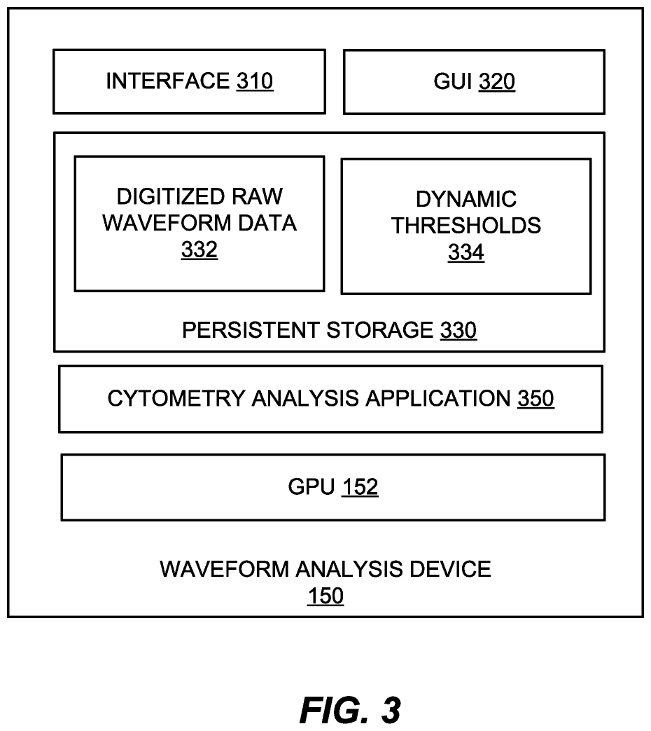

FIG. 3 schematically illustrates an example of the waveform analysis device 150. The waveform analysis device 150 receives, stores, and displays waveform data that has been continuously sampled without having been thresholded upstream at the waveform acquisition device 140. The waveform analysis device 150 includes an interface 310 to receive digitized raw waveform data 332, a persistent storage 330 to store the digitized raw waveform data 332, and can include a graphical user interface (GUI) 320 to display the digitized raw waveform data 332. The persistent storage 330 may also store a plurality of dynamic thresholds 334 that allow for non-linear thresholding and real-time updating and displaying of applied thresholds. The persistent storage 330 may comprise system memory such as random-access memory (RAM) and/or long-term non-volatile memory such as a hard drive.

The waveform analysis device 150 may further include a cytometry analysis application 350 comprising a software application or a set of related software applications configured to instruct the GPU 152 to process the digitized raw waveform data 332. The cytometry analysis application 350 may execute on one or more processors to provide the functionality described herein in conjunction with the GPU 152 such as receiving user input via the GUI 320. One or more components of the waveform analysis device 150 may reside in a cloud computing application in a network distributed system. In that regard, the waveform analysis device 150 may be any of a variety of computing devices, including, but not limited to, a personal computing device, a server computing device, or a distributed computing device.

In some instances, a user of a flow cytometer may be interested in using different sets of control variable values for configuring the flow cytometer to analyze particles. In such instances, the user would need to run multiple experiments for each set of control variable values. For example, the user would need to run a first experiment using a first set of control variable values, run a second experiment using a second set of control variable values, run a third experiment using a third set of control variable values, and so on until data has been collected for all desired sets of control variable values. As an illustrative example, a user of a flow cytometer who is interested in using voltage values of 500 v, 1000 v, and 1200 v for the FL1 detector would need to run a first experiment with a 500 v value set for the FL1 detector, edit the FL1 detector voltage to 1000 v and then re-run the experiment, and edit the FL1 detector voltage to 1200 v and then re-run the experiment. This is tedious and time consuming especially as the number of desired changes in the control variable values increases.

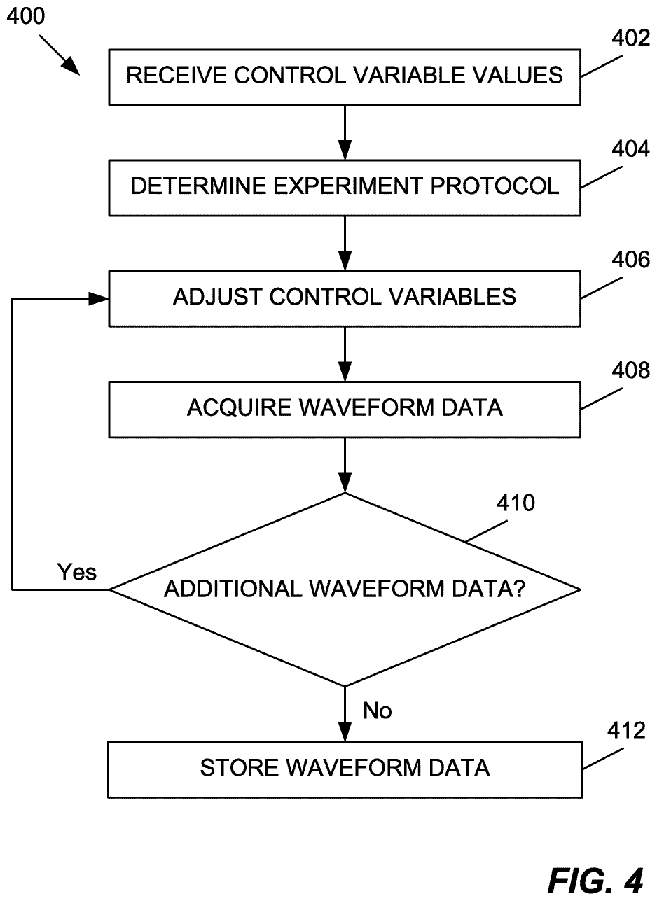

FIG. 4 schematically illustrates an example of a method 400 of performing a flow cytometry experiment by the flow cytometer system 100. As will be described in more detail, the method 400 eliminates the need to run multiple experiments for different sets of control variable values. Instead, a single experiment is run using different sets of control variable values.

The method 400 includes an operation 402 of receiving one or more sets of adjustable control variable values and an experiment duration. In some examples, the one or more sets of adjustable control variable values and the experiment duration can be received as user inputs via the GUI 144 of the waveform acquisition device 140.

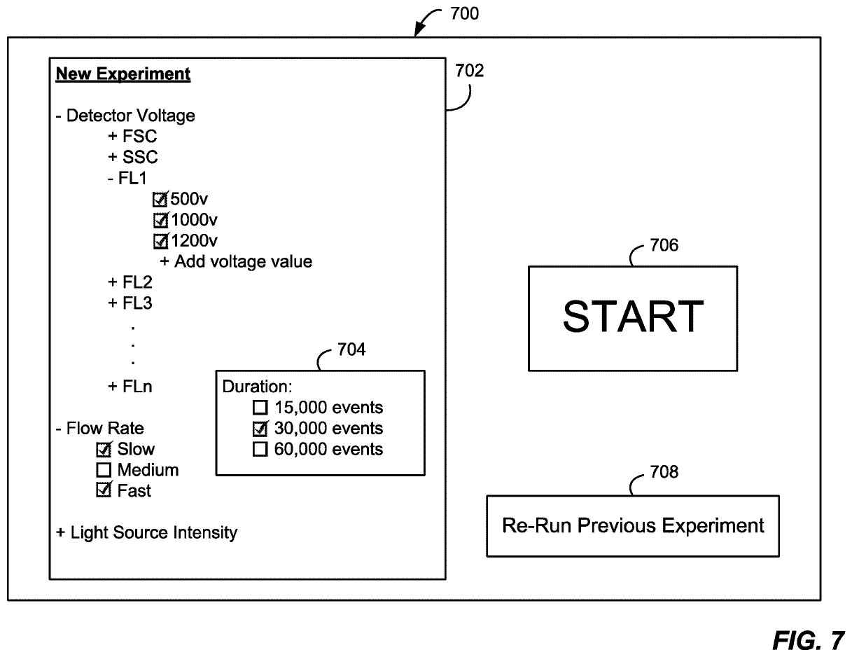

FIG. 7 illustrates an example of a graphical user interface (GUI) 700 that can be generated by the waveform acquisition device 140. The GUI 700 includes an experiment definition window 702 where one or more sets of control variable values are selected and/or entered by a user of the flow cytometer system 100. For example, the user can select a set of control variable values that include voltage values of 500 v, 1000 v, and 1200 v for the FL1 detector. While the example described herein refers to voltage values for the FL1 detector, it is contemplated that the aspects described herein can be applied to any of the detectors 124 that are included in the flow cytometer 101 (see FIG. 1). For example, the aspects described herein can be similarly applied to polychromatic detectors. Also, the term “voltage” as used herein is interchangeable with “gain” such that the aspects described herein may also be applied to adjust a gain of any amplifier, transducer, or detector of the flow cytometer 101.

In some examples, such as the one shown in FIG. 7, the voltage values for the FL1 detector are predefined such that the user simply selects one or more of the voltage values in the experiment definition window 702. In further examples, the user can enter one or more custom voltage values for the FL1 detector in the experiment definition window 702.

As shown in FIG. 7, the user can add additional voltage values for the FL1 detector by selecting “Add voltage value” icon to expand the options available for the FL1 detector. Also, the user can add voltage values for the other detectors in the optical system 120 (e.g., detectors FSC-FLn). Additionally, the user can select and/or enter additional control variable values such as flow rate values (e.g., sheath fluid flow rate and/or sample fluid flow rate values) for the fluidic system 110, and/or light beam intensity values for the light source 102.

As further shown in FIG. 7, the user can define an experiment duration in a window 704. In this example, the window 704 defines the experiment duration based on a quantity of detection events. As described above, a detection event can be a pulse such as the one shown in the plot 252 of FIG. 2C. In this example, the window 704 includes 15,000 events, 30,000 events, and 60,000 events as options for selection by the user, and a duration of 30,000 events is shown as selected. Additional experiment durations are possible such that these options are provided by way of illustrative example. Also, other types of units for defining the experiment duration can be specified in the window 704 such as time measured in seconds, minutes, or hours.

The GUI 700 includes a start icon 706 that can be selected by the user of the flow cytometer 101 to run the experiment based on the one or more sets of control variable values and the experiment duration selected in the experiment definition window 702.

Referring back to FIG. 4, the method 400 can include an operation 404 of determining an experiment protocol based on the one or more sets of adjustable control variable values and the duration set for the experiment. In some examples, the experiment protocol is automatically determined by the flow cytometer 101.

As an illustrative example, when the user selects the 500 v, 1000 v, and 1200 v voltage values for the FL1 detector and a duration of 30,000 events (see FIG. 7), operation 404 can include defining an experiment protocol that includes three different phases where 10,000 events are recorded at a first voltage value (e.g., 500 v) used by the FL1 detector, 10,000 events are recorded at a second voltage value (e.g., 1000 v) used by the FL1 detector, and 10,000 events are recorded at a third voltage value (e.g., 1200 v) used by the FL1 detector.

In alternative examples, the user can define a custom experiment protocol such as by using the GUI 144 of the waveform acquisition device 140. As an illustrative example, when the user selects the 500 v, 1000 v, and 1200 v voltage values for the FL1 detector and a duration of 30,000 events (see FIG. 7), the user can define a custom experiment protocol where 18,000 events are recorded at a first voltage value (e.g., 500 v) used by the FL1 detector, 6,000 events are recorded at a second voltage value (e.g., 1000 v) used by the FL1 detector, and 6,000 events are recorded at a third voltage value (e.g., 1200 v) used by the FL1 detector. Additional examples for determining the experiment protocol in operation 404 are possible.

Next, the method 400 includes an operation 406 of adjusting one or more control variables based on the experiment protocol determined in operation 404. For example, operation 406 can include adjusting the control variables to have values according to a first phase of the experiment protocol. In accordance with the illustrative example shown in FIG. 7 and described above, operation 406 can include adjusting the FL1 detector to have a voltage value of 500 v.

Next, the method 400 includes an operation 408 of acquiring the waveform data using the control variables adjusted in operation 406. For example, operation 408 can include operating the light source 102, fluidic system 110, and/or optical system 120 using the control variables values adjusted in operation 406. Following the illustrative example shown in FIG. 7, operation 408 can include operating the FL1 detector at a voltage value of 500 v to record 10,000 events.

Next, the method 400 includes an operation 410 of determining whether additional waveform data is needed based on the experiment protocol determined in operation 404. For example, operation 410 can include determining whether an additional phase of the experiment protocol needs to be completed. Following the illustrative example shown in FIG. 7 and described above, operation 410 can include determining whether additional events need to be recorded by the FL1 detector operating at different voltage values (e.g., 1000 v and 1200 v).

When it is determined in operation 410 that additional waveform data is needed (i.e., “Yes” in operation 410), the method 400 can return to operation 406 for adjusting the control variables to have values according to another phase of the experiment protocol. Following the illustrative example shown in FIG. 7 and described above, operation 406 can include adjusting the FL1 detector to have a voltage value of 1000 v. Thereafter, the method 400 can repeat operations 408, 410 until all phases of the experiment protocol have been completed such that no additional waveform data is needed (i.e., “No” at operation 410). Thus, the method 400 begins with the acquisition of waveform data using a predetermined set of one or more control variable values, and then, at predetermined intervals, changes one or more control variable values to acquire additional waveform data using different sets of control variable values.

When no additional waveform data is needed (i.e., “No” at operation 410), the method 400 can proceed to an operation 412 of storing the waveform data. In some examples, operation 412 includes storing the waveform data into a single flow cytometry standard (FCS) file. Following the illustrative example shown in FIG. 7, each event stored in the single FCS file is tagged with metadata to identify whether the event was detected under a 500 v, 1000 v, or 1200 v voltage value used by the FL1 detector during the experiment protocol.

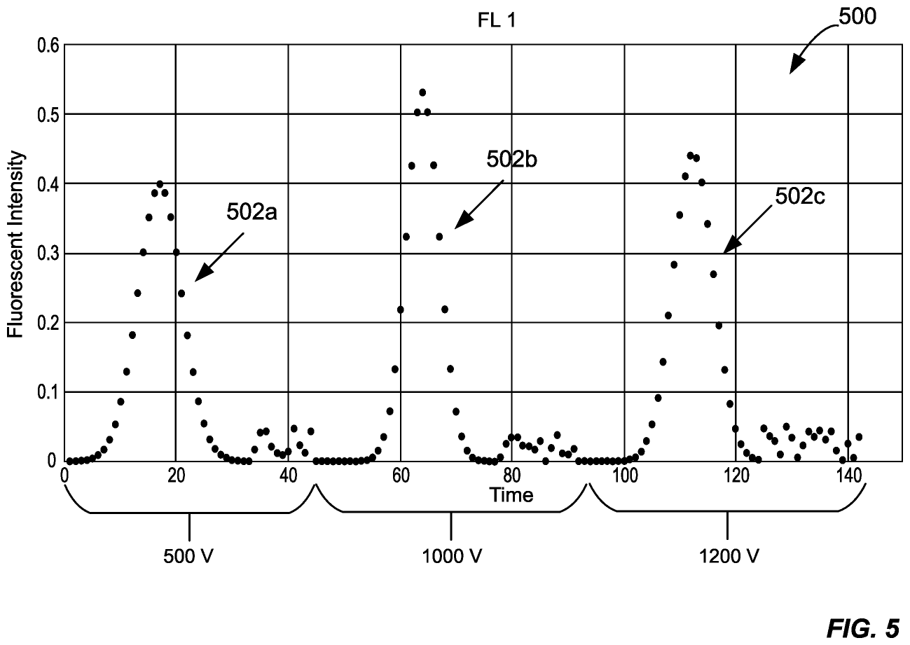

FIG. 5 graphically illustrates an example of a waveform 500 that can be generated after completion of the method 400. In this illustrative example, the waveform 500 is generated from data collected by the FL1 detector, where the x-axis is time, and the y-axis is fluorescent intensity. A user of the flow cytometer system 100 uses the GUI 144 of the waveform acquisition device 140 to specify that they want to collect data from the FL1 detector operating under voltage values of 500 v, 1000 v, and 1200 v for a total duration of 150 seconds. The waveform 500 is generated based on an experiment protocol that includes a first sequence of events 502a measured by the FL1 detector using a voltage value of 500 v for a time interval of 0-50 seconds, a second sequence of events 502b measured by the FL1 detector using a voltage value of 1000 v for a time interval of 50-100 seconds, and a third sequence of events 502c measured by the FL1 detector using a voltage value of 1200 v for a time interval of 100-150 seconds.

The first sequence of events 502a are tagged with metadata in the FCS file that associates these events as measured by the FL1 detector operating under a voltage of 500 v. Similarly, the second sequence of events 502b are tagged with metadata in the FCS file that associates these events as measured by the FL1 detector operating under a voltage of 1000 v. The third sequence of events 502c are tagged with metadata in the FCS file that associates these events as measured by the FL1 detector operating under a voltage of 1200 v.

In some examples, the single FCS file generated by the method 400 is transferred to the waveform analysis device 150 for storage in the persistent storage 330. Thus, the waveform analysis device 150 receives a digitized version of the waveform data that is not thresholded and available in its entirety for processing by the GPU 152. As discussed above, the GPU 152 enables thresholding of the waveform data at the post-processing step as opposed to the waveform acquisition step. This enables the waveform analysis device 150 to dynamically adjust thresholds and update graphical plots in real-time without re-running an experiment.

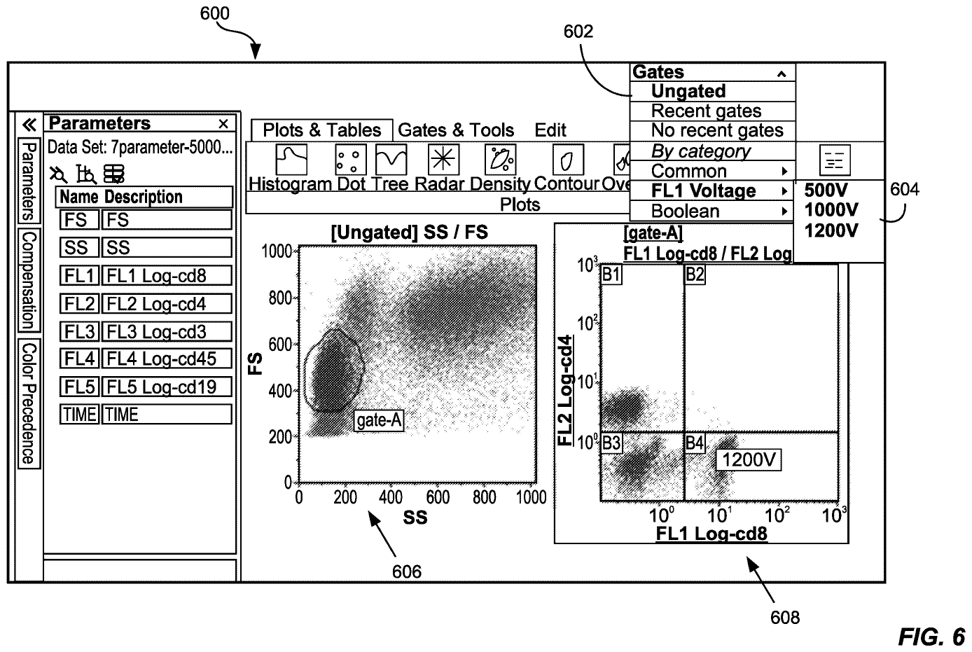

FIG. 6 illustrates an example of a graphical user interface (GUI) 600 that can be generated by the waveform analysis device 150 using the single FCS file generated by the method 400. As shown in FIG. 6, the GUI 600 can include a gating drop-down menu 602 that includes different gate options for selection by a user of the flow cytometer system 100. In this example, the gating drop-down menu 602 includes FL1 detector voltage which is selected causing a secondary drop-down menu 604 to display a list of values for this control variable.

In this example, the secondary drop-down menu 604 displays voltage values of 500 v, 1000 v, and 1200 v, which were used by the FL1 detector to detect the events in the waveform 500 of FIG. 5. As an illustrative example, a user of the flow cytometer system 100 can set an input gate for a scatter plot as “FL1 Voltage 500 v” to filter the events analyzed by the cytometry analysis application 350 of the waveform analysis device 150. In this example, only events that were measured by the FL1 detector operating at the voltage value of 500 v in the time interval 0-50 seconds are analyzed by the cytometry analysis application 350. Also, the events included in one or more plots 606, 608 on the GUI 600 are filtered to include only events that were measured by the FL1 detector operating at the voltage value of 500 v in the time interval 0-50 seconds.

In another example, the user of the flow cytometer system 100 can select more than one value for a control variable in the secondary drop-down menu 604. For example, a user of the flow cytometer system 100 can set an input gate for a scatter plot as “FL1 Voltage 500 v” and “FL1 Voltage 1000 v” to filter the events analyzed by the cytometry analysis application 350. In this example, events measured by the FL1 detector operating at the voltage values of 500 v in time interval 0-50 seconds and events measured by the FL1 detector operating at the voltage values of 1000 v in time interval 50-100 seconds are analyzed. Also, the events included in the one or more plots 606, 608 displayed in the GUI 600 are filtered to include only events that were measured by the FL1 detector operating at the 500 v and 1000 v voltage values.

In a further example, the user of the flow cytometer system 100 can select the 500 v, 1000 v, and 1200 v voltage values for the FL1 detector voltage such that events tagged with these voltage values are included in the one or more plots 606, 608 displayed in the GUI 600.

In further examples, multiple values can be selected for multiple control variables for acquiring the waveform data by the waveform acquisition device 140. For example, as shown in FIG. 7, a user of the flow cytometer system 100 can request waveform data acquisition for FL1 voltage values of 500 v, 1000 v, and 1200 v, and waveform data acquisition for slow and fast flow rates (but not a medium flow rate) for the sheath fluid flow rate and/or sample fluid flow rate that are controlled by the fluidic system 110. Adjusting the flow rate can be useful in distinguishing small particles from optical noise because when the flow rate is slowed, the width of small particles will dilate whereas the width of the optical noise (stray photons) will remain about constant. With the information in the signal improving and the noise staying constant, the signal-to-noise ratio can improve for the waveform data acquisition.

In this example, when the user requests a total duration of 60,000 events, an experiment protocol can be generated that includes the following sets of control variable values each used to detect 10,000 events: (1) FL1 voltage of 500 v, slow flow rate; (2) FL1 voltage of 1000 v, slow flow rate; (3) FL1 voltage of 1200 v, slow flow rate; (4) FL1 voltage of 500 v, fast flow rate; (5) FL1 voltage of 1000 v, fast flow rate; and (6) FL1 voltage of 1200 v, fast flow rate.

Additional examples of running a single experiment that uses multiples values for multiple control variables are possible such that the foregoing is provided for illustrative purposes only. For example, an intensity of the light beam generated by the light source 102 can be selected for adjustment between different values. Thus, a user of the flow cytometer system 100 can run a single experiment under different combinations of control variable values. This eliminates the need to run multiple experiments for different sets of control variable values. Instead, a single experiment is run using different sets of control variable values. This can save time and resources, and improves the usability of the flow cytometer system 100.

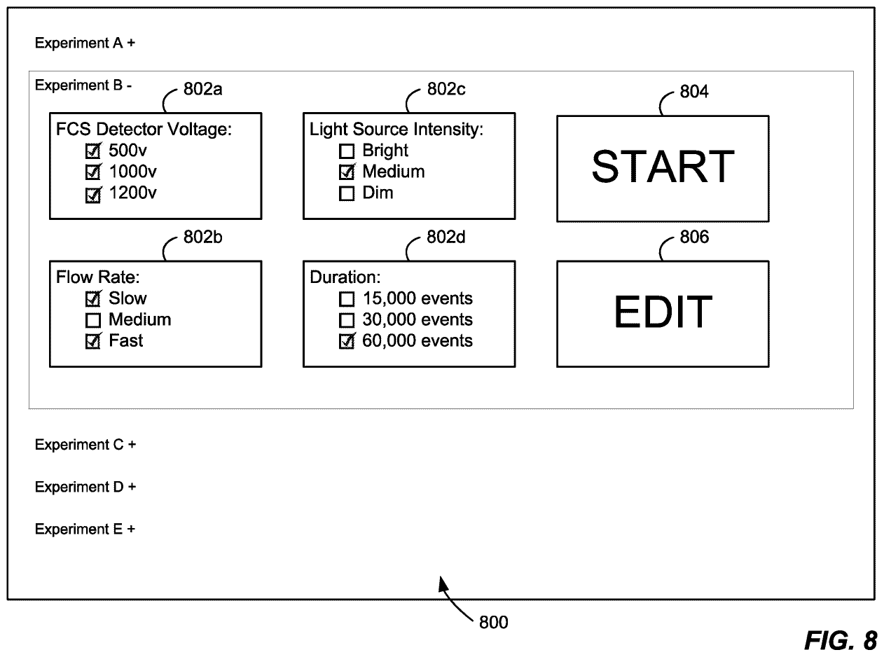

As further shown in FIG. 7, in some examples, a previous experiment having multiples values for one or more control variables can be re-run by a user selecting an icon 708. For example, after running a successful experiment, a user of the flow cytometer 101 can save the selected set of control variable values and the experiment duration in a memory of the waveform acquisition device 140 for repeating the experiment in the future. Upon selection of the icon 708, a graphical user interface (see FIG. 8) can be displayed by the waveform acquisition device 140 that lists previous experiments for selection by the user. In this manner, the user does not need to re-enter or re-select the values for the control variables and the experiment duration. Instead, the user can simply select a previous experiment to re-run it.

FIG. 8 illustrates an example of a graphical user interface (GUI) 800 generated by the waveform acquisition device 140 following a selection of the icon 708 in the GUI 700 of FIG. 7. In this illustrative example, the GUI 800 lists previous experiments that include an Experiment A, an Experiment B, an Experiment C, and so on. In the example shown in FIG. 8, the Experiment B is expanded showing multiples values selected for at least one control variable. In this example, an FCS detector voltage 802a includes selections of 500 v, 1000 v, and 1200 voltage values, and a flow rate 802b includes selections of slow and fast speeds. A light source intensity 802c includes a selection of a medium intensity, and an experiment duration includes a selection of 60,000 events. The user of the flow cytometer 101 can select the start icon 804 to re-run Experiment B without having to re-enter or re-select the values for the control variables, which can save time and resources.

In addition to the foregoing, in some instances, the previous experiments are associated with analyzing a particular particle or cell, or for identifying a particular characteristic on a particle or cell. For example, a previous experiment can be associated as being ideal for analyzing a particular type of cancer cell. Advantageously, the user of the flow cytometer 101 can select a previous experiment that is identified as optimal for a particular application without having the re-enter or re-select the values for the control variables of the experiment.

In some further examples, the GUI can further include an edit icon 806 that allows the user to edit the selection of values for the control variables for a given experiment. The edits can be saved such that the edited experiment can be re-run without the user having to re-enter or re-select the edited values for the control variables of the given experiment.

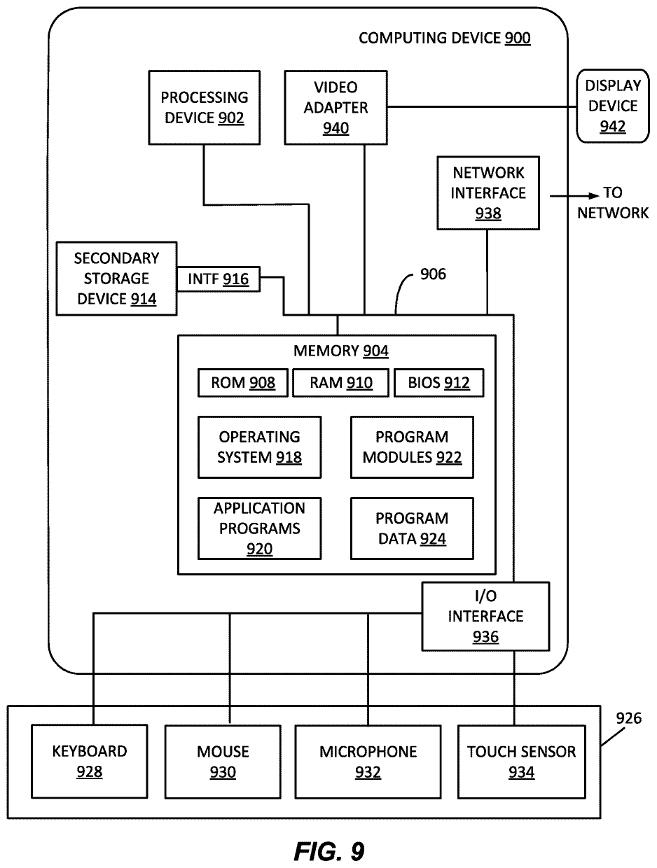

FIG. 9 illustrates an exemplary architecture of a computing device 900 that can be used to implement aspects of the present disclosure, including the aspects of the waveform acquisition device 140 and the waveform analysis device 150, as described above. The computing device 900 illustrated in FIG. 9 can be used to execute the operating system, application programs, and software modules (including the software engines) described herein.

The computing device 900 includes at least one processing device 902, such as a central processing unit (CPU). In this example, the computing device 900 also includes a system memory 904, and a system bus 906 that couples various system components including the system memory 904 to the at least one processing device 902. The system bus 906 is one of any number of types of bus structures including a memory bus, or memory controller; a peripheral bus; and a local bus using any of a variety of bus architectures.

The system memory 904 includes read only memory (ROM) 908 and random-access memory (RAM) 910. A basic input/output system 912 containing the basic routines that act to transfer information within computing device 900, such as during start up, is typically stored in the read only memory 908. In some examples, the system memory 904 has a large memory capacity, such as equal to or greater than one Terabyte of RAM. The RAM can be used to load and subsequently analyze the waveform data (e.g., the raw waveform data, such as stored in a raw waveform data file, which can include digitalized waveform data).

The computing device 900 also includes a secondary storage device 914 in some embodiments, such as a hard disk drive, for storing digital data. The secondary storage device 914 is connected to the system bus 906 by a secondary storage interface 916. In some examples, the secondary storage devices 914 and their associated computer readable media provide nonvolatile storage of computer readable instructions (including application programs and program modules), data structures, and other data for the computing device 900.

Although the exemplary environment described herein employs a hard disk drive as a secondary storage device, other types of computer readable storage media are used in other embodiments. Examples of these other types of computer readable storage media include magnetic cassettes, flash memory cards, digital video disks, Bernoulli cartridges, compact disc read only memories, digital versatile disk read only memories, random access memories, or read only memories. Some embodiments include non-transitory media. Additionally, such computer readable storage media can include local storage or cloud-based storage.

Several program modules can be stored in secondary storage device 914 or the system memory 904, including an operating system 918, one or more application programs 920, other program modules 922 (e.g., software engines described herein), and program data 924. The computing device 900 can utilize any suitable operating system, such as Microsoft Windows™, Google Chrome™, Apple OS, and any other operating system suitable for a computing device.

In some examples, a user provides inputs to the computing device 900 through one or more input devices 926. Examples of input devices 926 include a keyboard 928, mouse 930, microphone 932, and touch sensor 934 (such as a touchpad or touch sensitive display). Additional examples include additional types of input devices 926, or fewer types of input devices 926. The input devices 926 are connected to the at least one processing device 902 through an input/output interface 936 coupled to the system bus 906. The input/output interface 936 can include any number of input/output interfaces, such as a parallel port, serial port, game port, or a universal serial bus.

Wireless coupling between input devices 926 and the input/output interface 936 is possible as well, such as through infrared, BLUETOOTH®, 802.11a/b/g/n, cellular, or other radio frequency communication systems in some possible embodiments.

In this example embodiment, a display device 942, such as a monitor, liquid crystal display device, projector, or touch sensitive display device, is also connected to the system bus 906 via a video adapter 940. In addition to the display device 942, the computing device 900 can include various other peripheral devices (not shown), such as speakers or a printer.

When used in a local area networking environment or a wide area networking environment (such as the Internet), the computing device 900 is typically connected to a network such as through a network interface 938, such as an Ethernet interface. Other possible embodiments use other communication devices. For example, some embodiments of the computing device 900 include a modem for communicating across the network.

The computing device 900 typically includes at least some form of computer readable media. Computer readable media includes any available media that can be accessed by the computing device 900. By way of example, computer readable media include computer readable storage media and computer readable communication media.

Computer readable storage media includes volatile and nonvolatile, removable, and non-removable media implemented in any device configured to store information such as computer readable instructions, data structures, program modules or other data. Computer readable storage media includes, but is not limited to, random access memory, read only memory, electrically erasable programmable read only memory, flash memory, compact disc read only memory, digital versatile disks or other optical storage, magnetic cassettes, magnetic tape, magnetic disk storage or other magnetic storage devices, or any other medium that can be used to store the desired information and that can be accessed by the computing device. Computer readable storage media does not include computer readable communication media.

Computer readable communication media typically embodies computer readable instructions, data structures, program modules or other data in a modulated data signal such as a carrier wave or other transport mechanism and includes any information delivery media. The term “modulated data signal” refers to a signal that has one or more of its characteristics set or changed in such a manner as to encode information in the signal. By way of example, computer readable communication media includes wired media such as a wired network or direct-wired connection, and wireless media such as acoustic, radio frequency, infrared, and other wireless media. Combinations of any of the above are also included within the scope of computer readable media.

The computing device 900 illustrated in FIG. 9 is also an example of programmable electronics, which may include one or more such computing devices, and when multiple computing devices are included, such computing devices can be coupled together with a suitable data communication network to collectively perform the various aspects disclosed herein.

Although specific embodiments are described herein, the scope of the disclosure is not limited to those specific embodiments. The scope of the disclosure is defined by the following claims and any equivalents thereof.

1. A flow cytometer for analyzing particles, the flow cytometer comprising:
a light source generating a light beam toward an interrogation zone;
a fluidic system streaming the particles through the light beam in the interrogation zone;
an optical system including detectors for detecting radiated light from the particles streaming through the light beam in the interrogation zone; and
a processing circuitry having non-transitory computer readable storage media storing instructions which, when executed by the processing circuity, cause the processing circuitry to:
adjust one or more control variables of the light source, the fluidic system, and the optical system based on a first set of values;
acquire a sequence of waveform data from the particles streaming through the light beam in the interrogation zone under the first set of values for the one or more control variables; and
adjust the one or more control variables at predetermined intervals to acquire additional sequences of the waveform data using different sets of values for the one or more control variables.

2. The flow cytometer of claim 1, wherein the non-transitory computer readable storage media store additional instructions which, when executed by the processing circuitry, further cause the processing circuitry to:
determine the predetermined intervals based on the experiment duration and a quantity of the different sets of values for the one or more control variables.

3. The flow cytometer as in claim 1, wherein the non-transitory’ computer read able storage media store additional instructions which, when executed by the processing circuitry, further cause the processing circuitry to:
store the waveform data in a single flow cytometry standard file which tags each event in the waveform data to a predefined set of values for the one or more control variables.

4. The flow cytometer as in claim 1, wherein the non-transitory computer readable storage media store additional instructions which, when executed by the processing circuitry, further cause the processing circuitry to:
acquire the waveform data as a continuous digital stream of data without thresholding.

5. The flow cytometer as in claim 1, wherein the different sets of values for the one or more control variables are received via a graphical user interface.

6. The flow cytometer as in claim 1, wherein the experiment duration is based on a total number of events detected by the optical system.

7. The flow cytometer as in claim 1, wherein the experiment duration is based on time.

8. A method of analyzing particles flowing through an interrogation zone of a flow cytometer, the method comprising:
adjusting one or more control variables based on a first set of values, the one or more control variables being used to control operation of at least one of:
a light source generating a light beam toward the interrogation zone;
a fluidic system causing a flow of the particles through the light beam in the interrogation zone; and
an optical system for detecting one or more characteristics of the particles flowing through the light beam in the interrogation zone;
acquiring a sequence of waveform data from the particles flowing through the light beam in the interrogation zone under the first set of values for the one or more control variables; and
adjusting the one or more control variables at predetermined intervals to acquire additional sequences of the waveform data using different sets of values for the one or more control variables.

9. The method of claim 8, further comprising:
determining the predetermined intervals based on the experiment duration and a quantity of the different sets of values for the one or more control variables.

10. The method as in claim 8, further comprising:
storing the waveform data in a single flow cytometry standard file which tags each event in the waveform data to a predefined set of values for the one or more control variables.

11. The method as in claim 8, further comprising:
acquiring the waveform data as a continuous digital stream of data without thresholding.

12. The method as in claim 8, further comprising:
receiving the different sets of values for the one or more control variables via a graphical user interface.

13. The method as in claim 8, wherein the experiment duration is based on a total number of events detected by the optical system.

14. The method as in claim 8, wherein the experiment duration is based on time.

15. A non-transitory computer readable medium comprising program instructions, which when executed by a processor, cause the processor to:
adjust one or more control variables based on a first set of values, the one or more control variables being used to control operation of at least one of:
a light source generating a light beam toward an interrogation zone;
a fluidic system causing a flow of particles through the light beam in the interrogation zone; and
an optical system for detecting one or more characteristics of the particles flowing through the light beam in the interrogation zone;
acquire a sequence of waveform data from the particles flowing through the light beam in the interrogation zone under the first set of values for the one or more control variables; and
adjust the one or more control variables at predetermined intervals to acquire additional sequences of the waveform data using different sets of values for the one or more control variables until completion of an experiment duration.

16. The non-transitory computer readable medium of claim 15, further comprising additional program instructions, which when executed by a processor, further cause the processor to:
determine the predetermined intervals based on the experiment duration and a quantity⁷ of the different sets of values for the one or more control variables.

17. The non-transitory computer readable medium as in claim 15, further comprising program instructions, which when executed by a processor, further cause the processor to:
store the waveform data in a single flow cytometry’ standard file which tags each event in the waveform data to a predefined set of values for the one or more control variables.

18. The non-transitory’ computer readable medium as in claim 15, further comprising program instructions, which when executed by a processor, further cause the processor to:
acquire the waveform data as a continuous digital stream of data without thresholding.

19. The non-transitory computer readable medium as in claim 15. further comprising program instructions, which when executed by a processor, further cause the processor to:
receive the different sets of values for the one or more control variables via a graphical user interface.

20. The non-transitory computer readable medium as in claim 15, wherein the experiment duration is based on time, or a total number of events detected by the optical system.
